(19) United States
(12) Patent Application Publication
(10) Pub. No.: US 2006/0021607 A1
(43) Pub. Date: Feb. 2, 2006

(54) Engine ignition system

(75) Inventor: Makoto Toriyama, Chiryu-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/191,984

(22) Filed: Jul. 29, 2005

(30) Foreign Application Priority Data
Jul. 30, 2004 (JP) 2004-223605
Jun. 8, 2005 (JP) 2005-168465

(51) Int. Cl. F02P 3/06

(52) U.S. Cl. 123/598

(57) ABSTRACT

An engine ignition system has, in addition to a DC/DC converter for applying a first voltage to a primary winding of an ignition coil, a second DC/DC converter is provided for applying a second voltage higher than the first voltage to the primary winding. The second DC/DC converter operates only in a super lean-burn operation and causes a large secondary current having a magnitude of several hundreds of mA to flow through the secondary winding. Thus, the secondary current supplied to an ignition plug can be changed from a magnitude of several tens of mA in a normal operation to several hundreds of mA in the super lean-burn operation.

### CROSS REFERENCE TO RELATED APPLICATION

This application is based on and incorporates herein by reference Japanese Patent Applications No. 2004-223605 filed on Jul. 30, 2004 and No. 2005-168465 filed on Jun. 8, 2005.

### FIELD OF THE INVENTION

The present invention relates to an ignition system of an internal combustion engine. More particularly, the present invention relates to an ignition system capable of changing the magnitude of electrical energy, which is supplied to an ignition plug, in accordance with an operating state of the engine.

### BACKGROUND OF THE INVENTION

As an engine ignition system capable of changing the magnitude of an electrical energy, which is supplied to an ignition plug, in accordance with the operating state of an engine, it is proposed in U.S. Pat. No. 5,056,496 (JP 2,811,781) to change a period of supplying an alternating current (AC) current to an ignition plug. In this case, the period of supplying the AC current to the ignition plug corresponds to a period in which several ignitions are carried out.

An engine ignition system having the exemplary conventional configuration is shown in FIG. 3. This engine ignition system carries out several ignitions for each cylinder at one ignition timing. The engine ignition system has a DC/DC converter 2 and an ignition circuit 5. The DC/DC converter 2 is a first electrical-energy application means for boosting the voltage of a battery 6 mounted in a vehicle to serve as a DC power supply to a first voltage Vc. The ignition circuit 5 intermittently supplies a first electrical energy generated by the DC/DC converter 2 to a primary winding 4a of an ignition coil 4 provided for every cylinder.

The DC/DC converter 2 includes an energy accumulation coil 1, a first switch device 7 and a capacitor 3. The energy accumulation coil 1 is connected to the battery 6. The first switch device 7 is for turning on and off the flow of a current flowing to the energy accumulation coil 1. Examples of the first switch device 7 are an IGBT, a power transistor, a MOS-FET and a contact-type switch. The capacitor 3 is for accumulating an electrical energy discharged from the energy accumulation coil 1.

The energy accumulation coil 1 and the first switch device 7 form a series circuit between the positive and ground terminals of the battery 6. Electrical energy generated by the energy accumulation coil 1 is supplied to one terminal of the capacitor 3 and one terminal of the primary winding 4a by way of a diode 8 for preventing a current of the electrical energy from flowing back in the opposite direction from the terminals to the energy accumulation coil 1. It is to be noted that the inductance of the energy accumulation coil 1 is large.

The first switch device 7 is controlled so as to turn on and off by a driving current A output by a driving circuit 10. While an engine control unit (ECU) 11 is supplying an energy accumulation signal IGt at a high (Hi) level as shown in FIG. 4 to the driving circuit 10, the driving circuit 10 keeps the first switch device 7 in the turned-on state. The ECU 11 is a control apparatus for controlling the engine on the basis of a variety of sensor signals S1 to Sn. The driving circuit 10 has a function to repeatedly turn on and off the first switch device 7 at short ON and OFF periods coinciding respectively with OFF and ON periods of a second switch device 12 described later. The driving circuit 10 receives a discharging period signal IGw from the ECU 11 so as to repeatedly turn on and off the second switch device 12 at ON and OFF periods coinciding respectively with OFF and ON periods of the first switch device 7.

In addition, the driving circuit 10 also has a charging wait function to turn on and off the first switch device 7 to electrically charge the capacitor 3 and put the capacitor 3 in a wait state right after the operation to turn on and off the second switch device 12 is stopped.

The electrical charging side of the capacitor 3 is connected to the diode 8 and the primary winding 4a. The diode 8 is on the electrical-energy-discharging side of the energy accumulation coil 1. By connecting the capacitor 3 in this way, the electrical energy accumulated in the capacitor 3 is supplied to the primary winding 4a.

The ignition circuit 5 includes the second switch device 12 for turning on and off the current flowing through the primary winding 4a of the ignition coil 4 provided for each cylinder of the engine. Typically, the second switch device 12 is an IGBT, a power transistor, a MOS-FET or a contact-type switch.

The second switch device 12 receive the respective cylinder driving signals B#1, B#2, - - - and B#n output by the driving circuit 10 to turn on and off. The cylinder driving signals B#1, B#2, - - - and B#n, where suffix n denotes the number of engine cylinders, are each provided for the cylinder identified by suffix n.

While one discharging period signal IGw is being supplied to the driving circuit 10 from the ECU 11 at a Hi level, the driving circuit 10 repeatedly turns on and off the second switch device 12 provided for each cylinder at short periods. It is to be noted that, when the driving circuit 10 repeatedly turns on and off the second switch device 12 provided for each cylinder at short periods while the discharging period signal IGw is being supplied to the driving circuit 10 from the ECU 11, the driving circuit 10 repeatedly turns on and off the first switch device 7 at ON and OFF periods coinciding respectively with OFF and ON periods of the second switch device 12.

While the ECU 11 is supplying the energy accumulation signal IGt at the Hi level to the driving circuit 10, the first switch device 7 is kept in the turned-on state to gradually increase the electrical energy ie accumulated in the energy accumulation coil 1. Then, when the first switch device 7 is turned off, that is, when the second switch device 12 is turned on, the first electrical energy accumulated in the DC/DC converter 2 comprising the energy accumulation coil 1 and the capacitor 3 is supplied to the primary winding 4a of the ignition coil 4.

Thus, when the second switch device 12 is turned on, the first electrical energy accumulated in the DC/DC converter 2 comprising the energy accumulation coil 1 and the capacitor 3 is supplied to the primary winding 4a of the ignition coil 4, that is, the primary current i1 flows in the primary winding 4a. At that time, a rush current causes an ordinary secondary current i2 to flow through the secondary winding 4b of the ignition coil 4, generating spark electrical discharging (a CDI ignition) in the ignition plug. Subsequently, as the second switch device 12 is turned off, a reversed ordinary secondary current flows through the secondary winding 4b of the ignition coil 4 in a direction opposite to the ordinary secondary current flowing earlier due to an electrical energy accumulated in the ignition coil 4 as a result of the flow of the first primary current. The reversed ordinary secondary current flowing through the secondary winding 4b of the ignition coil 4 in the opposite direction causes spark electrical discharging (a full-transistor ignition) in the ignition plug.

That is, right after the energy accumulation signal IGt supplied by the ECU 11 to the driving circuit 10 changes from the Hi level to a low (Lo) level, the CDI ignition is carried out. While the discharging period signal IGw is being supplied to the driving circuit 10 from the ECU 11 at the Hi level, the driving circuit 10 repeatedly turns on and off the first switch device 7 at ON and OFF periods coinciding respectively with OFF and ON periods of the second switch device 12.

The above engine ignition system is adopted for an ordinary engine, which operates at the stoichiometric air-fuel mixture ratio or operating merely at the ordinary lean-burn air-fuel mixture ratio. In such an engine ignition system, the wave peak-to-peak amplitude i2p-p of the current flowing through the secondary winding 4b is several tens of mA. The current flowing through the secondary winding 4b at a wave peak-to-peak amplitude of several tens of mA is an ordinary secondary current.

In the engine ignition system produced in recent years, however, it is necessary to increase not only the length of the period, but also the absolute value of a current flowing to the ignition plug or, to be more specific, a secondary current, which flows through the secondary winding of an ignition coil in accordance with the operating state of the engine.

Specifically, to implement reliable firing under a severe combustion condition as is the case in a super lean-burn engine, a current of several hundreds of mA need be supplied to the ignition plug. As an example, in a super lean-burn engine, the air-fuel mixture ratio is set at a super lean air-fuel mixture ratio when a predetermined operating condition is satisfied. That is, the air-fuel mixture ratio is set at 30 or a greater value or, in some cases, the air-fuel mixture ratio is set at 50 or a greater value. When the super lean-burn operating condition is not satisfied, on the other hand, the super lean-burn engine is operated at the stoichiometric air-fuel mixture ratio or merely at the ordinary lean-burn air-fuel mixture ratio.

To reduce the amount of wear of the ignition plug and decrease the quantity of the power consumption of such an engine, in a condition not requiring a large current, it is necessary to limit the magnitude of current flowing through the ignition plug to a value of several tens of mA. Thus, in recent years, it is necessary to provide an engine ignition system capable of changing the magnitude of current flowing to the ignition plug from several tens of mA to several hundreds of mA and vice versa.

### SUMMARY OF THE INVENTION

It is thus an object of the present invention to provide an engine ignition system capable of changing the magnitude of current flowing to an ignition plug.

According to the present invention, in an engine ignition system which applies a first electrical energy to a primary winding of an ignition coil to generate an ordinary secondary current which flows through a secondary winding of the ignition coil by turning on and off flow of a primary current, a second electrical-energy is applied in addition to the first electrical energy for generating a large secondary current greater than the ordinary secondary current in the secondary winding.

Preferably the second electrical energy is generated by a DC/DC converter, and applied to either the primary winding or the secondary winding. The second electrical energy is applied only when an engine is in a super lean-burn operation.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing a simplified circuit of an engine ignition system according to a first embodiment of the present invention;

FIG. 2 is a time chart of a super lean-burn operation carried out by the engine ignition system according to the first embodiment;

FIG. 3 is a circuit diagram showing a simplified circuit of the conventional engine ignition system;

FIG. 4 is a time chart of a normal operation carried out by the conventional engine ignition system;

FIG. 5 is a circuit diagram showing a simplified circuit of an engine ignition system according to a second embodiment of the present invention;

FIG. 6 is a time chart of a super lean-burn operation carried out by the engine ignition system according to the second embodiment;

FIG. 7A is a simplified circuit diagram showing an engine ignition system according to a third embodiment of the present invention;

FIG. 7B is a time chart of an operation carried out by the engine ignition system according to the third embodiment;

FIG. 8 is a circuit diagram showing a simplified circuit of an engine ignition system according to a fourth embodiment of the present invention; and

FIG. 9 is a time chart of an operation carried out by the engine ignition system according to the fourth embodiment.

### DETAILED DESCRIPTION OF THE PREFERRED EMBODIMENT

### First Embodiment

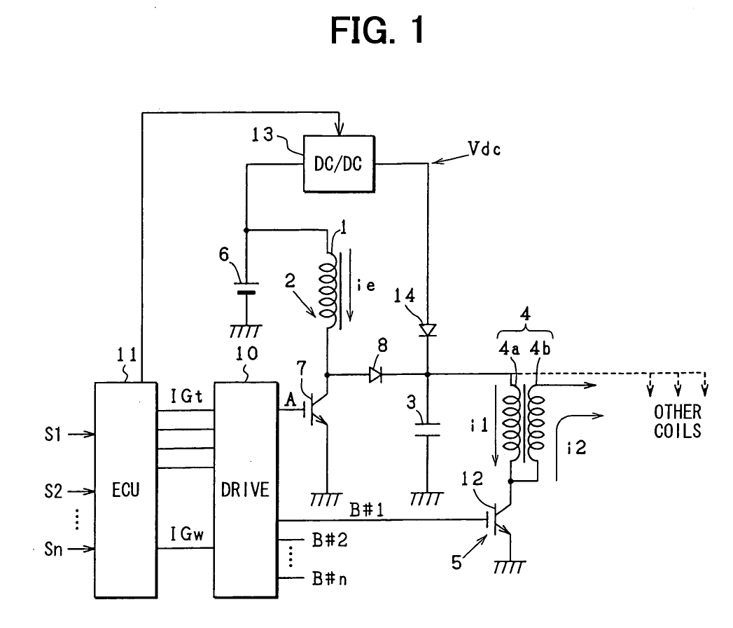

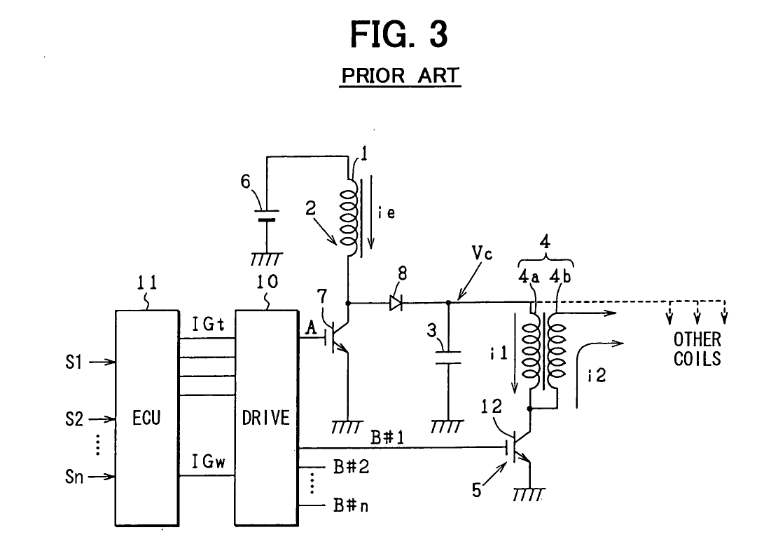

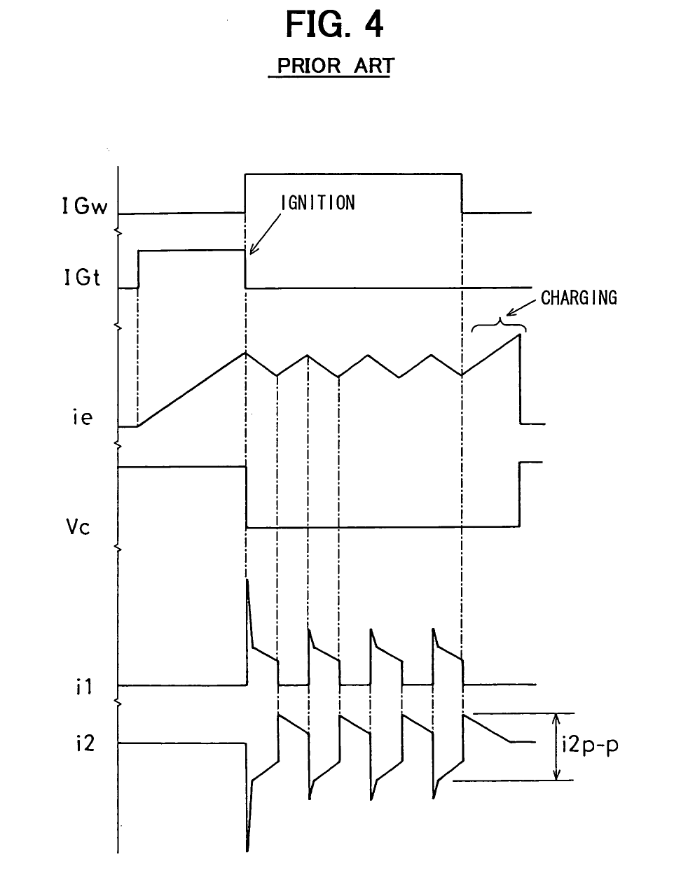

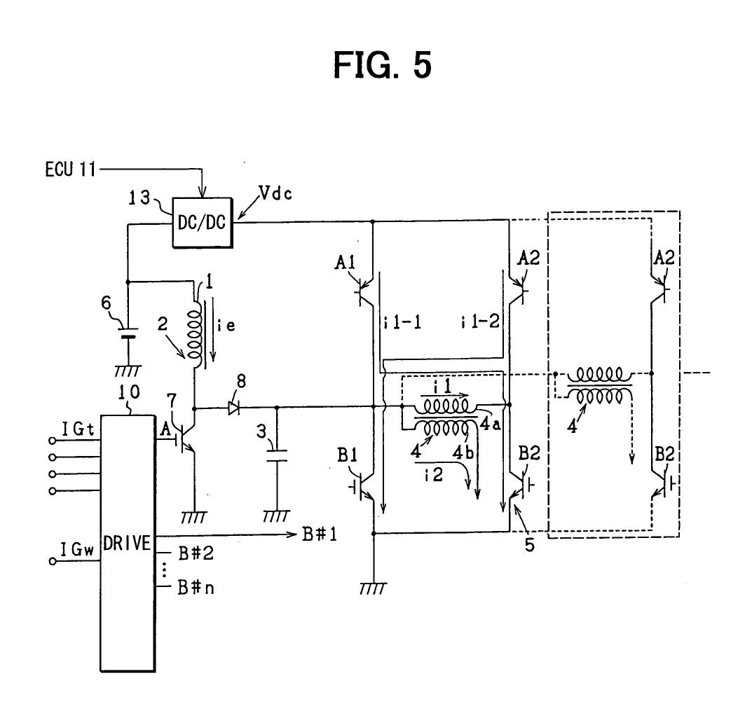

An ignition system for a super lean-burn engine is shown in FIG. 1, in which the same of similar part as the conventional system (FIG. 3) are designated with the same or similar numerals.

In the super lean-burn engine, to implement reliable firing at a super lean-burn air-fuel mixture ratio (that is, an air-fuel mixture ratio set at 30 or a greater value, in some cases, an air-fuel mixture ratio set at 50 or a greater value), it is necessary to flow a current having a magnitude of several hundreds of mA to an ignition plug. Such a current is a large secondary current.

On the other hand, the super lean-burn engine carries out a super lean-burn operation when a predetermined engine operating condition is satisfied. When a condition for a super lean-burn operation is not satisfied, however, the super lean-burn engine carries out an ordinary operation, which is an operation performed at the stoichiometric air-fuel mixture ratio or an operation performed merely at the ordinary lean-burn air-fuel mixture ratio.

Thus, to avoid dissipation of heat in the ignition plug and generation wear of the ignition plug in the normal operation, a wave peak-to-peak amplitude i2p-p of a current flowing through a secondary winding 4b in the engine ignition system mounted on the engine is set at several tens of mA or at the same value as the wave peak-to-peak amplitude of the ordinary secondary current. To implement reliable firing in the super lean-burn operation, however, the wave peak-to-peak amplitude i2p-p of the current flowing through the secondary winding 4b must be set at several hundreds of mA or at the same value as the wave peak-to-peak amplitude of the large secondary current.

To satisfy the above requirement, besides a first DC/DC converter 2 serving as the first electrical-energy application means, a second DC/DC converter 13 is provided as the second electrical-energy application means so that the secondary current flowing through the secondary winding 4b, that is, the current flowing to the ignition plug, can be switched from the ordinary secondary current to the large secondary current and vice versa.

By turning on and off the flow of the current through the primary winding 4a in a state of giving a second electrical energy to the primary winding 4a, it is possible to flow a large secondary current, which is greater than the ordinary secondary current, through the secondary winding 4b.

The second DC/DC converter 13 is for boosting the voltage generated by the battery 6 to a second voltage Vdc higher than the first voltage Vc. The second DC/DC converter 13 is a component that operates in a super lean-burn operation in accordance with an operation command signal output by the ECU 11. The second voltage Vdc obtained as a result of a voltage-boosting operation carried out by the second DC/DC converter 13 is applied to the primary winding 4a by way of a diode 14 for preventing a current from flowing back in the reverse direction to the second DC/DC converter 13.

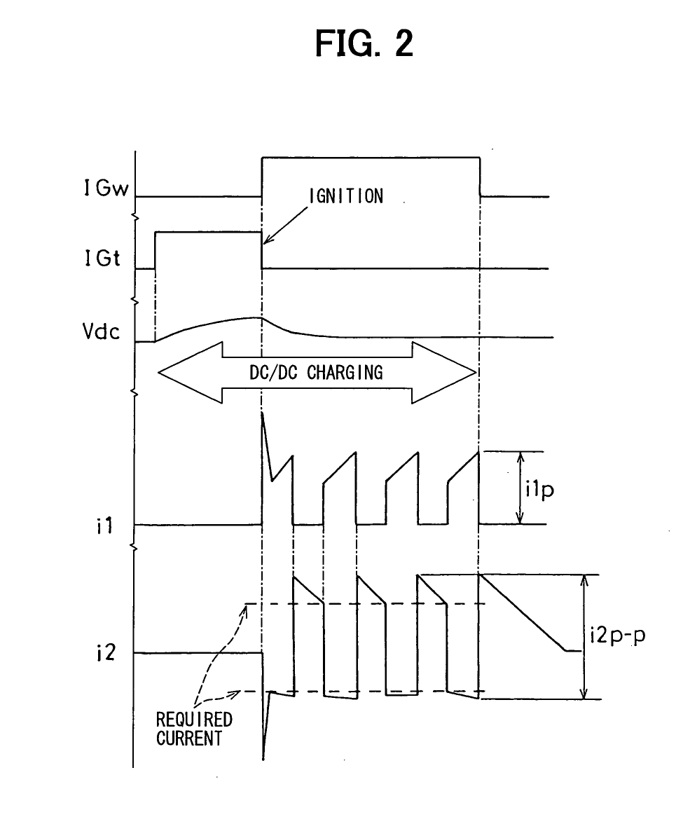

With the second DC/DC converter 13, a second voltage Vdc higher than the first voltage Vc is applied to one terminal of the primary winding 4a in the super lean-burn operation. Thus, as shown in FIG. 2, while the discharging period signal IGw is being supplied to the driving circuit 10 from the ECU 11 at the Hi level, that is, while the driving circuit 10 is repeatedly turning on and off the second switch device 12 and the first switch device 7 in such a way that the ON and OFF periods of the second DC/DC converter 13 coincide respectively with the OFF and ON periods of the first switch device 7, the second electrical energy greater than the electrical energy generated in the conventional configuration is given to the primary winding 4a of the ignition coil 4. As a result, a large secondary current greater than the ordinary secondary current flows through the secondary winding 4b of the ignition coil 4, causing several ignitions in which a large current with a magnitude of several hundreds of mA flows to the ignition plug.

It is preferred to change the magnitude of a required output current, which is made to flow to the ignition plug, smoothly or step by step in accordance with the operating state of the engine. Therefore, the ECU 11 controls the boosting quantity of the second DC/DC converter 13 in accordance with the operating state such as the air-fuel mixture ratio of the engine to adjust the second voltage Vdc generated by the second DC/DC converter 13. That is, the ECU 11 has a function of controlling the secondary current flowing through the secondary winding 4b, that is, the current flowing to the ignition plug.

The ECU 11 carries out this secondary current control function as follows:

(1) Find the magnitude of a required output current of, typically, the order of several hundreds of mA as a current magnitude optimum for the operating state of the engine.

(2) Find a current wave peak-to-peak amplitude i2p-p for obtaining the required output current. It is possible to directly find the current wave peak-to-peak amplitude i2p-p according to the operating state of the engine in operation (1).

(3) Find the wave height i1p of the primary current, which is used for generating the current wave peak-to-peak amplitude i2p-p found in operation (2) in the secondary winding 4b, on the basis of the winding ratio of the ignition coil 4. It is to be noted that the ratio of the wave height i1p to the current wave peak-to-peak amplitude i2p-p is inversely proportional to the winding ratio of the primary winding 4a to the secondary winding 4b.

(4) Find the second voltage Vdc to be output by the second DC/DC converter 13 as a voltage for resulting in the wave height i1p found in operation (3).

(5) Control the operation (or, to be more specific, the boosting quantity) of the second DC/DC converter 13 so as to generate the second voltage Vdc found in operation (4).

By carrying out operations (1) to (5), the required output current according to the operating state of the engine can be assured.

That is, by adjusting the boosting quantity of the second DC/DC converter 13 in accordance with the operating state of the engine, the magnitude of current flowing to the ignition plug can be changed from a small value to a large value and vice versa smoothly or step by step.

It is possible to provide a configuration in which the primary current flowing through the primary winding 4a is detected by using a primary-current monitor means such as a current detection resistor not shown in the figure, and the boosting quantity of the second DC/DC converter 13 is subjected to such feedback control that the primary current detected by using the primary-current monitor means matches a primary current corresponding to a target current wave peak-to-peak amplitude i2p-p according to the operating state of the engine. In this case, the target current wave peak-to-peak amplitude i2p-p is the magnitude of the large secondary current.

The engine ignition system according to the first embodiment has the second DC/DC converter 13 separately from the DC/DC converter 2. In the normal operation, the second DC/DC converter 13 does not operate. In the super lean-burn operation, on the other hand, the second DC/DC converter 13 operates.

In the normal operation, the second DC/DC converter 13 does not operate. Thus, the first electrical energy generated by the DC/DC converter 2 is applied to the primary winding 4a. As a result, the ordinary secondary current having the wave peak-to-peak amplitude i2p-p of several tens of mA flows to the secondary winding 4b.

In the super lean-burn operation, the second DC/DC converter 13 operates. Thus, the second voltage Vdc obtained as a result of the boosting operation carried out by the second DC/DC converter 13 is applied to the primary winding 4a. As a result, a large secondary current, which has a wave peak-to-peak amplitude i2p-p of several hundreds of mA and, is hence greater than the ordinary secondary current, flows to the secondary winding 4b.

As described above, the engine ignition system sets the magnitude of current made to flow to the ignition plug at several tens of mA in the normal operation as the conventional ignition system does but, in the super lean-burn operation, the current flowing to the ignition plug can be set at several hundreds of mA.

Thus, in the normal operation requiring no large secondary current, the magnitude of current made to flow to the ignition plug can be suppressed to several tens of mA so that it is possible to avoid wear of the ignition plug and a large power consumption.

In the super lean-burn operation requiring a large secondary current, on the other hand, the magnitude of current made to flow to the ignition plug can be increased to several hundreds of mA, making it possible to implement reliable firing under a severe combustion condition.

In addition, the boosting quantity of the second DC/DC converter 13 is changed in accordance with the operating state of the engine to vary the magnitude of current flowing to the ignition plug from a small value to a large value and vice versa smoothly or step by step. Thus, since the magnitude of current flowing to the ignition plug can be controlled optimally in accordance with the operating state of the engine, it is possible to avoid excessive wear of the ignition plug as well as excessive generation of heat and reduce the amount of consumed power generated by the battery 6.

It is possible to provide a configuration in which the primary current flowing through the primary winding 4a is detected by using a primary-current monitor means such as a current detection resistor not shown in the figure, and the boosting quantity of the second DC/DC converter 13 is subjected to feedback control based on the primary current detected by using the primary-current monitor means. By executing such feedback control, the precision of the magnitude of current to be applied to the ignition plug can be improved.

### Second Embodiment

In the second embodiment, the flow direction of the primary current flowing through the primary winding 4a is alternately reversed while the second electrical energy obtained as a result of a voltage-boosting operation carried out by the second DC/DC converter 13 is being supplied to the primary winding 4a, that is, while the discharging period signal IGw is being supplied to the driving circuit 10 from the ECU 11 at the Hi level in the super lean-burn operation.

For the current direction switching, the ignition system includes:

(1) a first application switch device Al for applying the output of the second DC/DC converter 13 to a specific one of terminals of the primary winding 4a;

(2) a second application switch device A2 for applying the output of the second DC/DC converter 13 to the other terminal of the primary winding 4a;

(3) a first ground switch device B1 for connecting the specific terminal of the primary winding 4a to the ground; and

(4) a second ground switch device B2 for connecting the other terminal of the primary winding 4a to the ground.

It is to be noted that the first application switch device Al and the first ground switch device B1 are both common to all cylinders. On the other hand, the second application switch device A2 and the second ground switch device B2 are provided for each cylinder or every ignition coil 4.

The first application switch device Al and the first ground switch device B1 are each typically an IGBT, a power transistor, a MOS-FET or a contact-type switch. Similarly, the second application switch device A2 and the second ground switch device B2 are each typically an IGBT, a power transistor, a MOS-FET or a contact-type switch. The second ground switch device B2 corresponds to the second switch device 12 employed in the first embodiment.

While the discharging period signal IGw is being supplied to the driving circuit 10 from the ECU 11 at the Hi level, the driving circuit 10 puts the first application switch device Al, the first ground switch device B1, the second application switch device A2 and the second ground switch device B2 in the following first and second states, which are established alternately:

(1) The first state in which the first application switch device A1 and the second ground switch device B2 are both in the turned-on state while the second application switch device A2 and the first ground switch device B1 are both in the turned-off state.

(2) The first state in which the first application switch device Al and the second ground switch device B2 are both in the turned-off state while the second application switch device A2 and the first ground switch device B1 are both in the turned-on state.

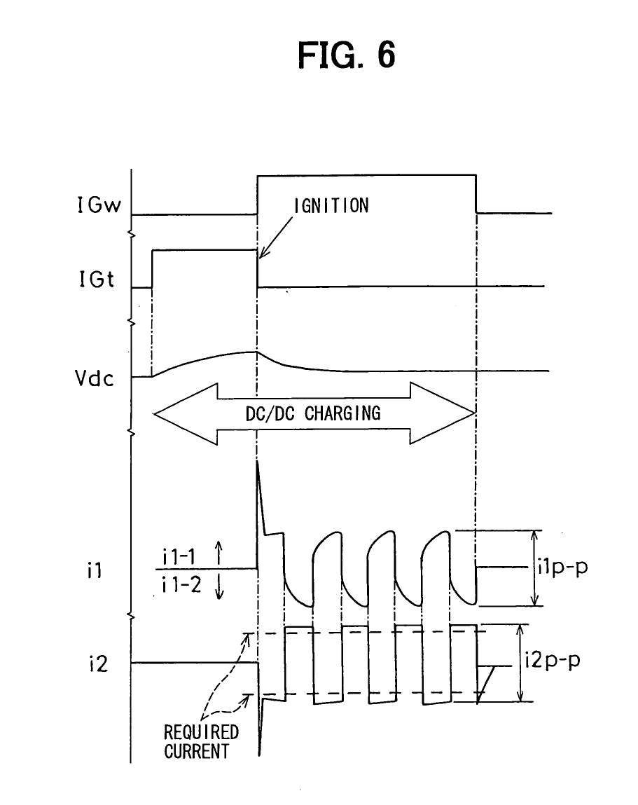

As a result, while the discharging period signal IGw is being supplied to the driving circuit 10 from the ECU 11 at the Hi level in the super lean-burn operation, the flow direction of the primary current flowing through the primary winding 4a is reversed alternately from the positive direction to the negative direction and vice versa as shown in FIG. 6.

Much like the first embodiment, the second embodiment changes the magnitude of a required output current, which is made to flow to the ignition plug, smoothly or step by step in accordance with the operating state of the engine. Specifically, the ECU 11 controls the boosting quantity of the second DC/DC converter 13 in accordance with the operating state such as the air-fuel mixture ratio of the engine to adjust the second voltage Vdc generated by the second DC/DC converter 13. As a result, the ECU 11 has a function of controlling the secondary current flowing through the secondary winding 4b, that is, the current flowing to the ignition plug.

Much like the first embodiment, the ECU 11 carries out the secondary current control as follows:

(1) Find the magnitude of the required output current of, typically, the order of several hundreds of mA as the current magnitude optimum for the operating state of the engine.

(2) Find the current wave peak-to-peak amplitude i2p-p for obtaining the required output current. It is possible to directly find the current wave peak-to-peak amplitude i2p-p according to the operating state of the engine in the operation (1).

(3) Find the wave peak-to-peak amplitude i1p-p of the primary current, which is used for generating the current wave peak-to-peak amplitude i2p-p found in operation (2) in the secondary winding 4b, on the basis of the winding ratio of the ignition coil 4. It is to be noted that the ratio of the wave peak-to-peak amplitude i1p-p to the current wave peak-to-peak amplitude i2p-p is inversely proportional to the winding ratio of the primary winding 4a to the secondary winding 4b.

(4) Find the second voltage Vdc to be output by the second DC/DC converter 13 as the voltage for resulting in the wave peak-to-peak amplitude i1p-p found in operation (3).

(5) Control the operation (or, to be more specific, the boosting quantity) of the second DC/DC converter 13 so as to generate the second voltage Vdc found in operation (4).

By carrying out the above operations (1) to (5), the required output current according to the operating state of the engine can be assured.

By adjusting the boosting quantity of the second DC/DC converter 13 in accordance with the operating state of the engine, the magnitude of current flowing to the ignition plug can be changed from a small value to a large value and vice versa smoothly or step by step.

It is possible to provide a configuration in which the primary current flowing through the primary winding 4a is detected by using a primary-current monitor means such as a current detection resistor not shown in the figure, and the boosting quantity of the second DC/DC converter 13 is subjected to such feedback control that the primary current detected by using the primary-current monitor means matches a primary current corresponding to a target secondary current according to the operating state of the engine. By executing such feedback control, the precision of the magnitude of current to be applied to the ignition plug can be improved.

The engine ignition system according to the second embodiment alternately reverses the flow direction of the primary current flowing through the primary winding 4a while the second electrical energy obtained as a result of the voltage-boosting operation carried out by the second DC/DC converter 13 is being supplied to the primary winding 4a, that is, while the discharging period signal IGw is being supplied to the driving circuit 10 from the ECU 11 at the Hi level in the super lean-burn operation. Thus, it is possible to reduce the magnitude of the primary current, that is, the magnitudes of positive and negative currents.

As a result, dissipation of heat in the second DC/DC converter 13 and the ignition coil 4 can be avoided. In addition, the sizes of the second DC/DC converter 13 and the ignition coil 4 as well as the weights thereof can be reduced.

### Third Embodiment

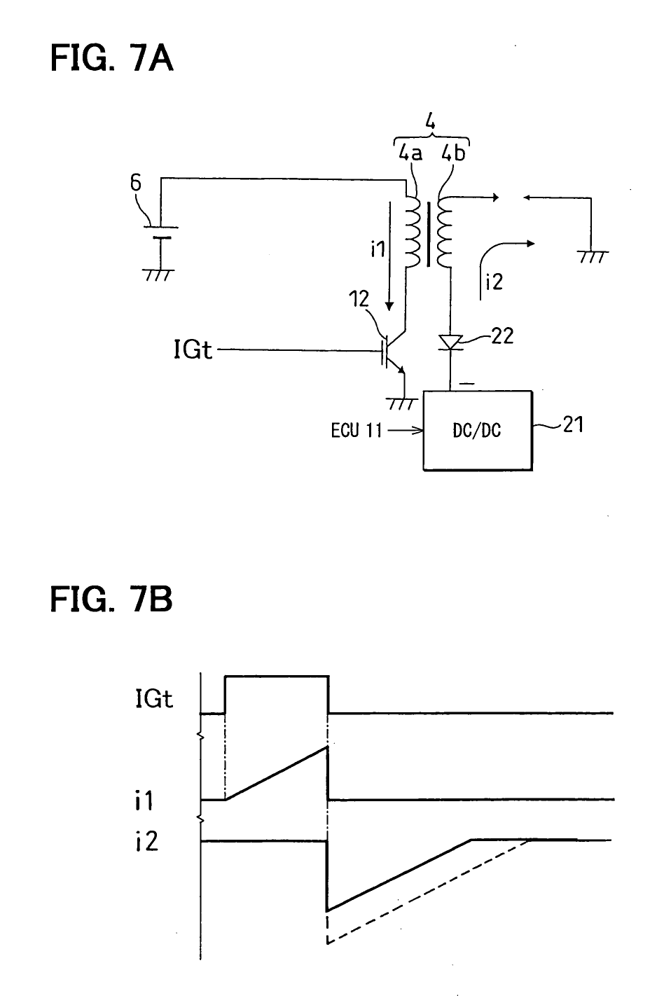

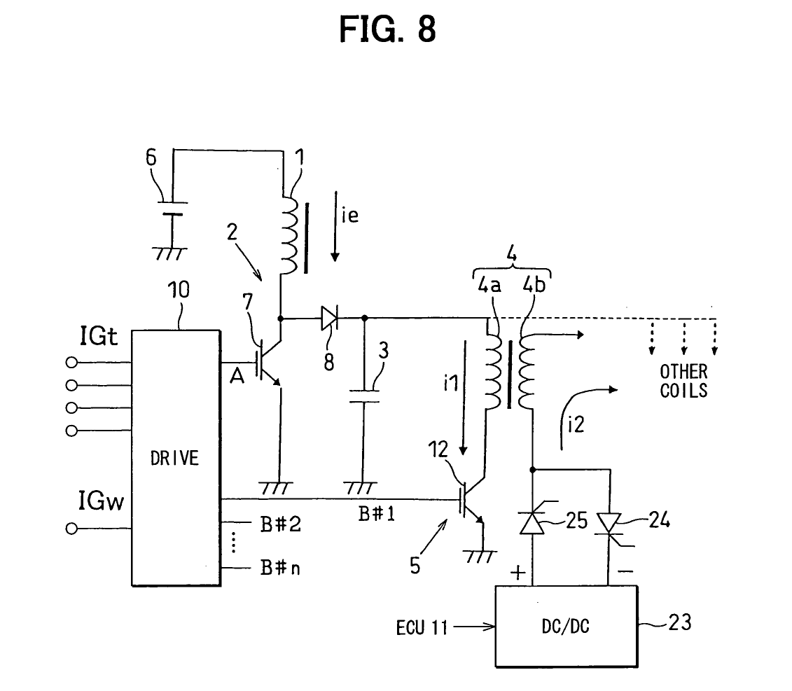

In the third embodiment, the ignition system is constructed in the full-transistor type, which directly applies the voltage of the battery 6 to the primary winding 4a of the ignition coil 4 as shown in FIG. 7A. Thus, the battery 6 operates as the first electrical-energy application means.

The second switch device 12 is connected in series to the primary winding 4a so that, by turning the second switch device 12 on and off, the flow of the current through the primary winding 4a can also be turned on and off.

The second switch device 12 is turned on when the energy accumulation signal IGt received from the driving circuit 10 or the ECU 11 is set at the Hi level. The driving circuit 10 and the ECU 11 are the same driving circuit 10 and the ECU 11, which are employed in the first embodiment. When the second switch device 12 is turned on, the primary current flows from the battery 6 to the primary winding 4a. Thus, while the energy accumulation signal IGt is being received from the driving circuit 10 or the ECU 11 at the Hi level as shown in FIG. 7B, the first electrical energy is supplied to the primary winding 4a so that the electrical energy is accumulated gradually in the ignition coil 4.

Then, when the second switch device 12 is turned off, due to the electrical energy accumulated in the ignition coil 4, the ordinary secondary current shown by a solid line in the figure flows through the secondary winding 4b in the negative direction, resulting in spark electrical discharging (full-transistor ignition).

The third embodiment includes a DC/DC converter 21 as the second electrical-energy application means for directly generating a large secondary current greater than the ordinary secondary current in the secondary winding 4b with a timing to generate the ordinary secondary current. This DC/DC converter 21 increases the ordinary secondary current flowing through the secondary winding 4b in the negative direction to the large secondary current also flowing in the same negative direction upon termination of the flow of the current through the primary winding 4a. Typically, the ordinary secondary current having the magnitude of several tens of mA is increased to the large secondary current having a magnitude of several hundreds of mA.

The DC/DC converter 21 is a component for generating a negative voltage as a negative electrical-discharge sustaining voltage capable of sustaining an electrical discharging voltage generated in the secondary winding 4b in the negative direction as a voltage of −several kV. A unit employed in the DC/DC converter 21 for generating the electrical discharging voltage is connected to the ground side of the secondary winding 4b through a diode 22 for preventing a current from flowing in the reversed direction from the DC/DC converter 21 to the secondary winding 4b. It is to be noted that the DC/DC converter 21 is a negative-voltage generation apparatus for generating the electrical-discharge sustaining voltage in an operation driven by the electrical energy provided by the battery 6.

When the ECU 11, which is the same as that employed in the first embodiment, produces an operation command to the DC/DC converter 21 for example in the super lean-burn operation, the DC/DC converter 21 operates to stop the flow of the current through the primary winding 4a and generate the ordinary secondary current in the secondary winding 4b in the negative direction. At that time, the DC/DC converter 21 increases the ordinary secondary current flowing through the secondary winding 4b in the negative direction to the large secondary current also flowing in the same negative direction. Thus, the large current indicated by a dashed line in FIG. 7B flows through the secondary winding 4b in the negative direction.

As a result, by operating the DC/DC converter, the DC/DC converter stops the flow of the current through the primary winding 4a and generates the ordinary secondary current in the secondary winding 4b in the negative direction. At that time, the DC/DC converter increases the ordinary secondary current flowing through the secondary winding 4b in the negative direction to the large secondary current also flowing in the same negative direction. For example, the ordinary secondary current flowing through the secondary winding 4b at the typical magnitude of several tens of mA is increased to the large secondary current having the typical magnitude of several hundreds of mA.

By keeping the DC/DC converter 21 in the inoperative state during the normal operation (other than super lean-burn operation), this ignition system is capable of setting the magnitude of current flowing to the ignition plug at several tens of mA as is the case with the conventional engine ignition system. In the super lean-burn operation, on the other hand, the DC/DC converter 21 is capable of operating to set the magnitude of the current flowing to the ignition plug at several hundreds of mA, which are a value greater than the magnitude of the current for the conventional engine ignition system.

Thus, much like the first embodiment, in the normal operation requiring no large current, the magnitude of the current flowing to the ignition pug can be suppressed so that wear of the ignition plug and a large power consumption can be avoided. In the super lean-burn operation requiring a large current, on the other hand, the magnitude of the current flowing to the ignition plug can be increased and reliable firing can be implemented under a severe combustion condition.

It is to be noted that the magnitude of current output by the DC/DC converter 21 can also be changed to vary the magnitude of the current flowing to the ignition plug from the small value to the large one and vice versa smoothly or step by step. By changing the magnitude of current output by the DC/DC converter in this way, the magnitude of the current flowing to the ignition plug can be controlled to the value optimum for the operating state of the engine. Thus, it is possible to avoid excessive wear of the ignition plug and excessive generation of heat. As a result, excessive consumption of power generated by the battery 6 can be avoided.

In the case of the third embodiment, the primary current flows through the secondary winding 4b in the negative direction at an ignition time. Even in the case of an implementation in which a current flows through the secondary winding 4b in the positive direction at the ignition time, a large secondary current greater than the ordinary secondary current flowing through the secondary winding 4b in the positive direction can be generated directly in the secondary winding 4b.

In this case, the polarities of the DC/DC converter 21 and the diode 22 are reversed. In an operation to stop the flow of the current through the primary winding 4a and generate the ordinary secondary current in the secondary winding 4b in the positive direction, the DC/DC converter 21 increases the ordinary secondary current also in the positive direction from the typical magnitude of several tens of mA to the typical magnitude of several hundreds of mA. That is, the DC/DC converter generates a positive voltage capable of sustaining an electrical discharging voltage generated in the secondary winding 4b as a voltage of several kV.

Thus, in the case of a configuration in which the current flows through the secondary winding 4b in the positive direction at the full-transistor ignition time, the current flowing to the ignition plug can be switched from the typical magnitude of several tens of mA to the typical magnitude of several hundreds of mA and vice versa.

### Fourth Embodiment

In the fourth embodiment, like the third embodiment, a DC/DC converter 23 is provided to increase the ordinary secondary current flowing through the secondary winding 4b in the negative direction to the large secondary current also flowing in the same negative direction upon termination of the flow of the current i1 through the primary winding 4a. Typically, the ordinary secondary current flowing in the negative direction at the magnitude of several tens of mA is increased to the large secondary current having a magnitude of several hundreds of mA. In addition, the DC/DC converter 23 also increases an ordinary secondary current flowing through the secondary winding 4b in the positive direction to the large secondary current also flowing in the same positive direction upon termination of the flow of the current i1 through the primary winding 4a. Typically, the ordinary secondary current flowing in the positive direction at the magnitude of several tens of mA is increased to the large secondary current having the magnitude of several hundreds of mA.

The DC/DC converter 23 is a component for generating a negative voltage as a negative electrical-discharge sustaining voltage capable of sustaining an electrical discharging voltage generated in the secondary winding 4b in the negative direction as a voltage of −several kV. Similarly, the DC/DC converter 23 is also a component for generating a positive voltage as a positive electrical-discharge sustaining voltage capable of sustaining electrical discharging voltage generated in the secondary winding 4b in the positive direction as a voltage of +several kV. A unit employed in the DC/DC converter 23 as a unit for generating the electrical discharging voltage on the negative side is connected to the ground side of the secondary winding 4b through a negative-voltage application gate 24 which may be a first thyristor (SCR). On the other hand, a unit employed in the DC/DC converter 23 as a unit for generating the electrical discharging voltage on the positive side is connected to the ground side of the secondary winding 4b through a positive-voltage application gate 25 which may be a second thyristor (SCR). It is to be noted that the DC/DC converter 23 is a positive/negative-voltage generation apparatus for generating the electrical-discharge sustaining voltage in an operation driven by the electrical energy provided by the battery 6.

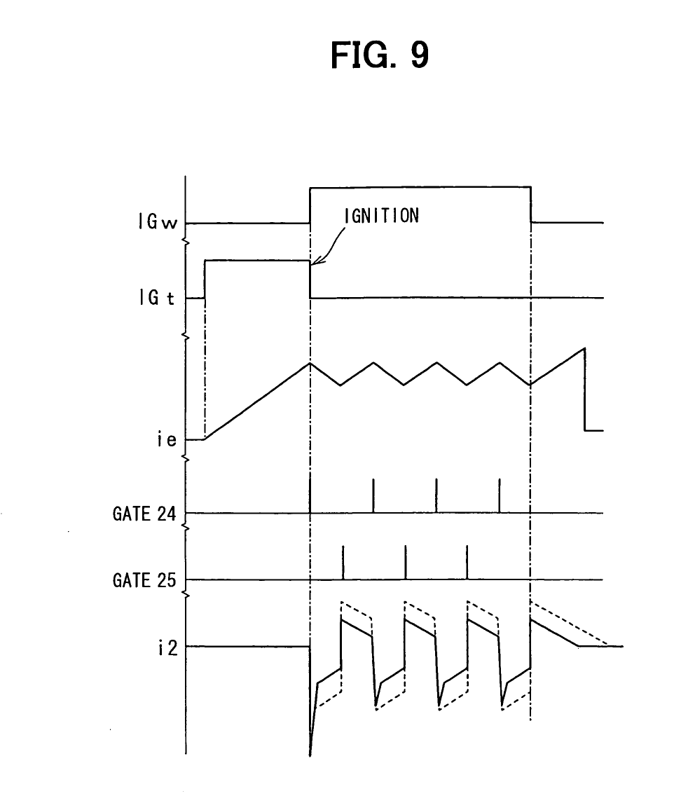

When the ECU 11, which is the same as that employed in the first embodiment, gives an operation command to the DC/DC converter 23 for example in the super lean-burn operation, the DC/DC converter 23 operates to open the negative-voltage application gate 24 (that is, to turn on the first thyristor) at a timing to generate the ordinary secondary current in the secondary winding 4b in the negative direction so as to increase the ordinary secondary current flowing through the secondary winding 4b in the negative direction to the large secondary current also flowing in the same negative direction as shown in FIG. 9. Thus, the large current indicated by the dashed line in FIG. 9 flows through the secondary winding 4b in the negative direction. Then, at a timing to generate the ordinary secondary current in the secondary winding 4b in the positive direction, on the other hand, the DC/DC converter 23 operates to open the positive-voltage application gate 25 (that is, to turn on the second thyristor) so as to increase the ordinary secondary current flowing through the secondary winding 4b in the positive direction to the large secondary current also flowing in the same positive direction.

As a result, the large secondary current indicated by the dashed line in FIG. 9 flows through the secondary winding 4b in the positive and negative directions. It is to be noted that the solid line shown in FIG. 9 represents the waveform of the ordinary secondary current, which flows through the secondary winding 4b when the DC/DC converter 23 is not operating, that is, when both the negative-voltage application gate 24 and the positive-voltage application gate 25 are not opened or in the normal operation different from the super lean-burn operation.

As described above, by operating the DC/DC converter 23, the DC/DC converter 23 increases the ordinary secondary current flowing through the secondary winding 4b in the negative direction to the large secondary current also flowing in the same negative direction at the timing to generate the ordinary secondary current in the secondary winding 4b in the negative direction. For example, the ordinary secondary current flowing in the negative direction through the secondary winding 4b at the typical magnitude of −several tens of mA is increased to the large secondary current having the typical magnitude of −several hundreds of mA. In addition, the DC/DC converter 23 also increases the ordinary secondary current flowing through the secondary winding 4b in the positive direction to the large secondary current also flowing in the same positive direction with the timing to generate the ordinary secondary current in the secondary winding 4b in the positive direction. For example, the ordinary secondary current flowing in the positive direction through the secondary winding 4b at the typical magnitude of +several tens of mA is increased to the large secondary current having the typical magnitude of +several hundreds of mA.

By keeping the DC/DC converter 23 in the inoperative state during the normal operation, the engine ignition system according to the fourth embodiment is capable of setting the magnitude of current flowing to the ignition plug at several tens of mA as is the case with the conventional engine ignition system. In the super lean-burn operation, on the other hand, the fourth DC/DC converter 23 is capable of operating to set the magnitude of the current flowing to the ignition plug at several hundreds of mA, which is a value greater than the magnitude of the current for the conventional engine ignition system.

Thus, much like the first embodiment, in the normal operation requiring no large current, the magnitude of the current flowing to the ignition plug can be suppressed so that wear of the ignition plug and a large power consumption can be avoided. In the super lean-burn operation requiring a large current, on the other hand, the magnitude of the current flowing to the ignition plug can be increased and reliable firing can be implemented under a severe combustion condition.

It is to be noted that the magnitude of current output by the DC/DC converter 23 can also be changed to vary the magnitude of the current flowing to the ignition plug from the small value to the large one and vice versa smoothly or step by step. By changing the magnitude of current output by the DC/DC converter 23 in this way, the magnitude of the current flowing to the ignition plug can be controlled to a value optimum for the operating state of the engine. Thus, it is possible to avoid excessive wear of the ignition plug and excessive generation of heat. As a result, excessive consumption of power generated by the battery 6 can be avoided.

In the above embodiments, it should be noted that the DC/DC converters provided as the second electrical-energy application means can also be driven to operate not only in the super lean-burn operation, but also in other operations in which a large ignition energy is required to be applied to ignition plugs.

What is claimed is:

1. An engine ignition system comprising:
an ignition coil having a primary winding and a secondary winding;
a first electrical-energy application means for applying a first electrical energy to the primary winding, wherein an ordinary secondary current is generated to flow through the secondary winding by turning on and off flow of a primary current through the primary winding with the first electrical energy applied to the primary winding; and
a second electrical-energy application means, provided in addition to the first electrical-energy, for applying a second electrical energy and generating a large secondary current greater than the ordinary secondary current in the secondary winding.

2. An engine ignition system according to claim 1, wherein:
the second electrical-energy application means applies the second electrical energy to the primary winding, the second electrical energy being greater than the first electrical energy; and
the large secondary current is generated by turning on and off the flow of the primary current through the primary winding with the second electrical energy applied to the primary winding.

3. An engine ignition system according to claim 2, wherein:
the first electrical-energy application means is a first DC/DC converter for boosting a voltage of by a battery mounted in a vehicle to a first voltage;
the second electrical-energy application means is a second DC/DC converter for boosting the voltage of the battery mounted in the vehicle to a second voltage higher than the first voltage; and
a multi-ignition means is further provided for repeatedly turning on and off the flow of the primary current through the primary winding at short periods while a control apparatus produces a multiple-ignition signal.

4. An engine ignition system according to claim 3, further comprising:
a secondary-current control means for controlling the secondary current flowing through the secondary winding by adjusting a boosting quantity of the second DC/DC converter in accordance with operating state of an engine.

5. An engine ignition system according to claim 4, wherein:
the secondary-current control means detects the primary current flowing through the primary winding and adjusts the secondary current flowing through the secondary winding by executing feedback control on the boosting quantity of the second DC/DC converter on the basis of the primary current.

6. An engine ignition system according to claim 3, further comprising:
a current direction switching means for alternately reversing a direction of the primary current flowing through the primary winding while a second voltage produced by boosting operation of the second DC/DC converter is applied to the primary winding.

7. An engine ignition system according to claim 1, wherein:
the first electrical-energy application means is connected to the primary winding; and
the second electrical-energy application means is connected to the secondary winding for directly generating a large secondary current greater than the ordinary secondary current in the secondary winding.

8. An engine ignition system according to claim 7, wherein:
the first electrical-energy application means is a battery mounted on a vehicle; and
the second electrical-energy application means is a DC/DC converter, which increases a magnitude of an ordinary secondary current flowing through the secondary winding upon termination of the flow of a primary current flowing through the primary winding.

9. An engine ignition system according to claim 7, wherein:
the first electrical-energy application means is a DC/DC converter for boosting a voltage generated by a battery mounted in a vehicle to a first voltage;
a multi-ignition means is provided for repeatedly turning on and off the flow of a primary current through the primary winding at short periods while a control apparatus produces a multiple-ignition signal; and
the second electrical-energy application means is a DC/DC converter, which increases a magnitude of an ordinary secondary current flowing through the secondary winding in both positive and negative directions when the ordinary secondary current flowing in the same positive and negative directions is generated in the secondary winding upon termination of the flow of a primary current flowing through the primary winding.

10. An engine ignition system according to claim 1, further comprising:
a control means for operating the second electrical-energy application means only when an engine is in a super lean-burn operation in which an air-fuel mixture ratio is set to be more than 30.
